(19) United States
(12) Patent Application Publication
(10) Pub. No.: US 2013/0197898 A1
(43) Pub. Date: Aug. 1, 2013

(54) METHOD AND APPARATUS FOR TRANSLATION

(71) Applicant: Electronics and Telecommunications Research Institute, Daejeon (KR)

(72) Inventors: Mi Ran CHOI, Daejeon (KR); Hyun Ki KIM, Daejeon (KR); Jeong HEO, Daejeon (KR); Pum Mo RYU, Daejeon (KR); Yeo Chan YOON, Seoul (KR); Chang Ki LEE, Daejeon (KR); Yoon Jae CHOI, Chuncheon (KR); Myung Gil JANG, Daejeon (KR); Chung Hee LEE, Daejeon (KR); Hyeon Jin KIM, Daejeon (KR); Hyo Jung OH, Daejeon (KR); Yo Han JO, Seoul (KR)

(73) Assignee: Electronics and Telecommunications Research Institute, Daejeon (KR)

(21) Appl. No.: 13/713,511

(22) Filed: Dec. 13, 2012

(30) Foreign Application Priority Data
Feb. 1, 2012 (KR) 10-2012-0010534
Jul. 12, 2012 (KR) 10-2012-0075974

(51) Int. Cl. G06F 17/28

(52) U.S. Cl. CPC G06F 17/28
USPC 704/3

(57) ABSTRACT

Disclosed is an apparatus for providing an accurate automatic language translation service. A user terminal according to an exemplary embodiment of the present invention includes a display unit to display a translation option setting menu for a user with respect to a source sentence of which a category is designated and to be translated; a user input unit to receive, from the user, an input on setting of a translation option; a communication unit to transmit the translation option to a translation server, and to receive a translation result from the translation server; and a control unit to control operations of the display unit, the user input unit, and the communication unit. According to the present invention, a translation service for multilingual multimedia through a natural styled highly precise automatic translation is enabled.

### CROSS-REFERENCE TO RELATED APPLICATIONS

This application claims priority to and the benefit of Korean Patent Application No. 10-2012-0010534 filed in the Korean Intellectual Property Office on Feb. 1, 2012, and Korean Patent Application No. 10-2012-0075974 filed in the Korean Intellectual Property Office on Jul. 12, 2012, the entire contents of which are incorporated herein by reference.

### TECHNICAL FIELD

The present invention relates to a method for providing an accurate automatic translation service, and more particularly, to a method that defines a protocol message using an automatic translation service and a variety of language options in order to provide a natural advanced automatic translation service, and provides an accurate automatic translation service using the defined protocol message.

### BACKGROUND ART

A variety of technologies have been developed to provide a multilingual multimedia service. For example, motion picture experts group (MPEG)-M, that is, multimedia service platform technology (MSPT) is a standard about a method of processing multimedia and expression and structure thereof. For an MPEG-M basic service, a language translation service is required for users that need translation of many languages. A variety of multimedia used in an MPEG-M multimedia service platform requires an automatic language translation service of accurate technology according to a demand of a user that needs translation of many languages. To provide a service based on a platform such as MPEG-M, for example, to provide a multilingual service of contents close to a living such as contents for an Internet protocol television (IPTV) in a natural form, more accurate automatic language translation technology is required.

### SUMMARY OF THE INVENTION

The present invention has been made in an effort to provide a method that provides a natural translation result close to a source language by defining a protocol to enable an automatic translation service and employing a protocol message expression method using a variety of language information.

The present invention provides a method that may variously change a translation option and enables a user to more intuitively set the translation option.

An exemplary embodiment of the present invention provides a user terminal, including: a display unit to display a translation option setting menu for a user with respect to a source sentence of which a category is designated and to be translated; a user input unit to receive, from the user, an input on setting of a translation option; a communication unit to transmit the translation option to a translation server, and to receive a translation result from the translation server; and a control unit to control operations of the display unit, the user input unit, and the communication unit.

The translation option received by the user input unit may be a translation option with respect to the entire data or at least one partial data of the source sentence. The translation option received by the user input unit may be a translation option that is determined based on the category of the source sentence.

The translation option received by the user input unit may be a translation option for each author with respect to at least one author selected from the source sentence.

The translation option received by the user input unit may be a translation option for each language with respect to at least one language selected from the source sentence.

The communication unit may include: a message generator to generate a translation request message for requesting translation of the source sentence using the translation option; a transmitter to transmit, to a data translation apparatus, the translation request message generated by the message generator; and a receiver to receive, from a source sentence translation apparatus, a sentence that is translated based on the translation option. The translation option may include source language information used to define a language of the source sentence, target language information used to define a target language for translating the source sentence, and information indicating whether an expression style of the target language is formal or informal. The translation option may be a translation option that is selectable based on the source language or the target language.

The source sentence may be data having a motion picture experts group (MPEG)-M based format.

Another exemplary embodiment of the present invention provides a method of providing a translation service, the method including: displaying a translation option setting menu for a user with respect to a source sentence of which a category is designated and to be translated; receiving, from the user, an input on setting of a translation option; transmitting the translation option to a translation server, and receiving a translation result from the translation server; and displaying the translation result.

The translation option received in the receiving may be a translation option with respect to the entire data or at least one partial data of the source sentence.

The translation option received in the receiving may be a translation option that is determined based on the category of the source sentence.

The translation option received in the receiving may be a translation option for each author with respect to at least one author selected from the source sentence.

The translation option received in the receiving may be a translation option for each language with respect to at least one language selected from the source sentence.

The transmitting and the receiving may include: generating a translation request message for requesting translation of the source sentence using the translation option; transmitting, to a data translation apparatus, the translation request message generated in the generating; and receiving, from a source sentence translation apparatus, a sentence that is translated based on the translation option.

The translation option may include source language information used to define a language of the source sentence, target language information used to define a target language for translating the source sentence, and information indicating whether an expression style of the target language is formal or informal. The translation option may be a translation option that is selectable based on the source language or the target language.

The source sentence may be data having an MPEG-M based format.

Still another exemplary embodiment of the present invention provides a translation service providing method of a translation server, the method including: receiving, from a user terminal, a source sentence of which a category is designated and to be translated and a translation option of the source sentence; translating the source sentence by applying the translation option; and transmitting the translation result to the user terminal.

The translation option received in the receiving may be a translation option that is determined based on the category of the source sentence.

The translation option received in the receiving may be a translation option for each author with respect to at least author one selected from the source sentence.

The translation option received in the receiving may be a translation option for each language with respect to at least one language selected from the source sentence.

According to exemplary embodiments of the present invention, a translation service for multilingual multimedia through a natural styled highly precise automatic translation is enabled by providing a method of performing an automatic language translation service in a multimedia platform, for example, MPEG-M, that is, multimedia service platform technology (MSPT).

According to exemplary embodiments of the present invention, a user may more easily set a translation option of language translation by providing a more intuitive user interface system in defining option information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exemplary diagram illustrating a network configuration for providing a translation service according to an exemplary embodiment of the present invention.

FIG. 2 is a block diagram illustrating a configuration of a user terminal according to an exemplary embodiment of the present invention.

FIG. 3 is an exemplary diagram illustrating a translation option setting screen displayed on a display unit of a user terminal according to an exemplary embodiment of the present invention.

FIGS. 4 and 5 are exemplary diagrams illustrating a translation option setting screen based on category information displayed on a display unit of a user terminal according to an exemplary embodiment of the present invention.

FIG. 6 is an exemplary diagram illustrating a translation option setting screen for each area displayed on a display unit of a user terminal according to an exemplary embodiment of the present invention.

FIG. 7 is an exemplary diagram illustrating a translation option setting screen for each author displayed on a display unit of a user terminal according to an exemplary embodiment of the present invention.

FIG. 8 is an exemplary diagram illustrating a translation option setting screen for each language displayed on a display unit of a user terminal according to an exemplary embodiment of the present invention.

FIG. 9 is a flowchart illustrating a method of providing a translation service according to an exemplary embodiment of the present invention.

FIG. 10 is a detailed flowchart of the translation service providing method of FIG. 9.

FIG. 11 is a flowchart illustrating a translation service providing method of a translation server according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. In the following description and the accompanying drawings, like reference numerals refer to like constituent elements and thus, a repeated description will be omitted. When it is determined that the detailed description related to a related known function or configuration may make the purpose of the present invention unnecessarily ambiguous in describing the present invention, the detailed description will be omitted here.

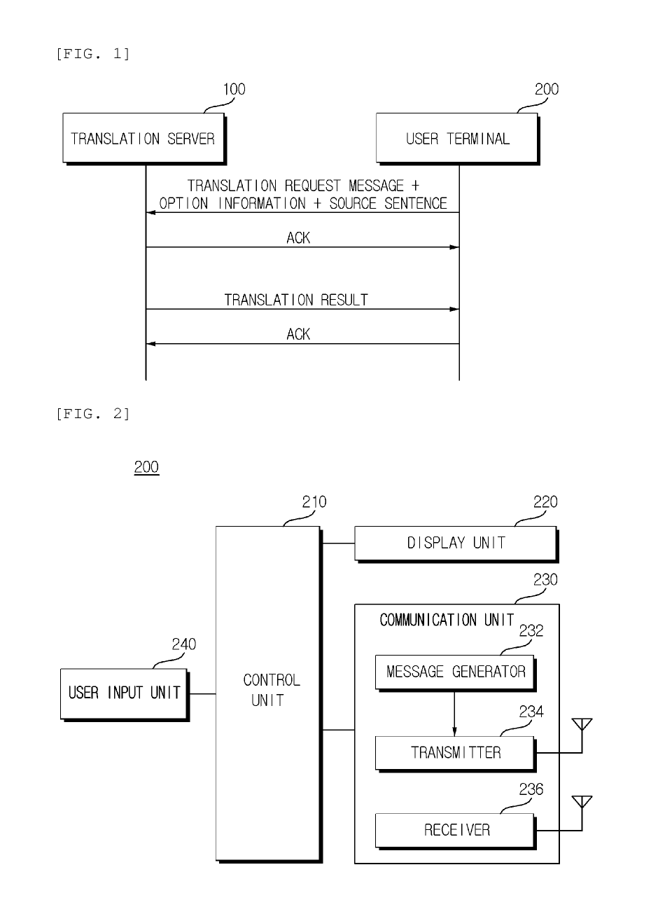

FIG. 1 is an exemplary diagram illustrating a network configuration for providing a translation service according to an exemplary embodiment of the present invention. Referring to FIG. 1, a user terminal 200 making a request for translation is connected to a translation server 100 through a predetermined communication method enabling data communication. The user terminal 200 transmits a translation request message and a source sentence to the translation server 100. The translation server 100 having normally received the above data transfers an acknowledgement (ACK) signal indicating that translation is possible since the translation server 100 has normally received the source sentence.

The translation server 100 translates the source sentence to a translated sentence by applying a translation option of the received translation request message. In the present exemplary embodiment, the translation server 100, as a data translation apparatus, translates the source sentence requested to be translated using a target language and then transmits a message indicating that the translation is completed. For example, according to a motion picture experts group (MPEG)-M standard, the translation server 100 may transmit a ProcessContentCompletion message to the user terminal 200 having made a request for translation. The ProcessContentCompletion message is a translation response message indicating completion of translation including the translated sentence. Accordingly, a receiver receives the translated sentence in which the source sentence is translated by a source sentence translation apparatus based on the translation option. A communication unit having received the translated sentence transmits an ACK signal indicating that the translation translated by the source sentence translation apparatus is normally received.

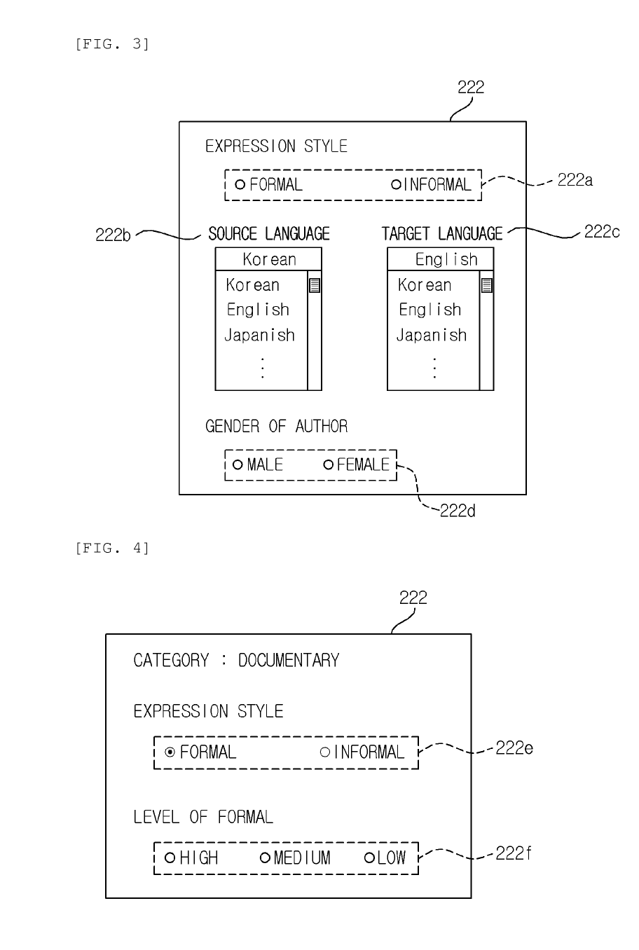

FIG. 2 is a block diagram illustrating a configuration of the user terminal 200 according to an exemplary embodiment of the present invention.

The user terminal 200 may be a predetermined computing apparatus enabling data communication. For example, the user terminal 200 may be a desktop, a laptop, a table, a hand-held computer, a personal computer (PC), a mobile phone, a smart phone, a personal digital assistance (PDA), a media player, an electronic device, and another predetermined computing apparatus.

The user terminal 200 includes a control unit 210 to execute a command and to perform an operation associated with the command. For example, using a command retrieved from a memory (not shown), a processor may control receiving and processing of input and output data between components of a computer system.

The control unit 210 may be configured as a dedicated or embedded processor, a single-purpose processor, a controller, an application specific integrated circuit (ASIC), and the like.

The user terminal 200 may also include a display unit 220 connected to the control unit 210 to thereby operate. The display unit 220 may be a liquid crystal display (LCD), an organic light emitting diode (OLED) solid color display, a color graphics adaptor (CGA) display, an enhanced graphics adaptor (EGA) display, a variable graphics array (VGA) display, a super VGA display, a cathode ray tube (CRT), and another predetermined display apparatus. In the present exemplary embodiment, the user terminal 200 displays a menu for selecting a translation option definable by the user for the user and receives an input of the defined translation option from the user, based on a translation service protocol predetermined with respect to a source sentence to be translated.

A communication unit 230 may make a request for translating the source sentence using a translation option received by a translation option input unit or a predetermined default translation option, or may receive a sentence in which the source sentence is translated based on the translation option, and may include a message generator 232, a transmitter 234, and a receiver 236.

The message generator 232 generates a translation request message for requesting translation of the source sentence using the translation option. The translation request message generated by the message generator 232 may be the aforementioned process content message including the source sentence to be substantially translated and translation options to designate a translation style of a translated sentence as a result of translating the source sentence.

The transmitter 234 transmits, to the translation server 100, the translation request message generated by the message generator 232.

A user input unit 240 transfers, to the control unit 210, an input signal received from a user. The user input unit 240 may be a predetermined input device or input module such as a touch pad, a mouse, a keyboard, a trackball, and the like. The input signal may be a user input for setting the translation option.

Meanwhile, the display unit 220 and the user input unit 240 may be configured as a single device, for example, a touch screen. In the present exemplary embodiment, the display unit 220 displays a translation option setting menu for the user with respect to the source sentence of which category is designated and to be translated.

The source sentence indicates data including text information that the user desires to be translated. The source sentence includes text data that is prepared using at least one source language.

The translation option indicates an option item that is defined by the user or a predetermined algorithm to obtain translation data further satisfying a user requirement from a translation source sentence. The predetermined algorithm indicates a set of commands with respect to a process of pre-determining a translation option through additional information such as the category of the translation source sentence or enabling an action of recommending the user the translation option to be performed on a computer processor. In the present exemplary embodiment, the translation option includes source language information used to define a language of the source sentence and target language information used to define a language of the translated sentence.

The translation option includes information indicating whether an expression style of the target language is formal or informal. The translation option may include information indicating an author or audience of the source sentence. The translation option may vary based on which language is used for the source language of the source sentence or the target language.

According to an exemplary embodiment, a translation option according to a data type format of a message generated using translation options may be defined as illustrated in Table 1.

TABLE 1

| Name | Definition |
|---|---|
| TranslateLanguage | Parameters for the ProcessContentRequest |
| Type | message of Service Type “Translate |
| | Language”. It contains necessary and |
| | optional parameters for the Translate |
| | Language Service Type. |
| | TranslateLanguageType extends |
| | mpegmb:RequestParametersBaseType. |
| SourceLanguage | Indicates the language of the input text. |
| | Candidate source languages are provided as |
| | an option. |
| TargetLanguage | Indicates the language of the output text |
| | which is the result text of the |
| | translation from the source language. |
| | Candidate source languages are provided as |
| | an option. |
| DomainInfo | Domain of the content to be translated |
| | (e.g., science, weather, drama). |
| | As a default, a specific domain is given |
| | from the document provider. |
| | The user can change the domain when he |
| | requests the translation service. |
| taggedInput | Input tagged for specifying the optional |
| | features such as formal/informal, |
| | male/female for parts of the input |
| outputType | Indicates the translated output is single |
| | or multiple. In case of multiple output, |
| | the user can choose the one of his |
| | preference |
| linguisticStyle | Indicates the linguistic register or style |
| | of the output text such as formal style or |
| | informal style which is important for |
| | highly advanced natural translation in |
| | some languages where formality is |
| | expressed morphologically. |
| | Other values that are data type-valid with |
| | respect to mpeg7:termReferenceType are |
| | reserved. |
| | EXAMPLE The 1^{st} person singular “you” can |
| | be translated to German as either “du” in |
| | informal style or as “Sie” in formal |
| | style. |
| writerGender | Gender of the writer for target languages |
| | that have linguistic differentiation of |
| | the author's gender. |
| | EXAMPLE The English text “I am happy” can |
| | be translated to Spanish either as “Estoy |
| | contenta” for a female author or as “Estoy |
| | contento” for a male author. |
| audienceGender | Gender of the audience for target |
| | languages that have linguistic |
| | differentiation of the audience's gender. |
| | EXAMPLE The English text “Are you happy?” |
| | can be translated to Spanish either as |
| | “ [symbol] Estás contenta?” for a female audience |
| | or as “ [symbol] Estás contento?” for a male |
| | audience. |
| audienceAgeSpan | Specify if the intended reader is a child |
| | for target languages that have linguistic |
| | differentiation of the audiences age span. |

Referring to Table 1, options SourceLanguage indicating the source language and TargetLanguage indicating the target language are essential. linguisticStyle is an option for indicating formality/informality of an expression style. When a morphological change such as an ending change is present in formal and informal language styles such as Korean and Japanese, the above option is useful. DomainInfo is an option for indicating a domain of content to be translated, and provides a function that enables the user to select another domain even though a domain of a sentence is classified in advance and thereby is input as a predetermined domain. An option writerGender may indicate a gender of an author and thereby generate a translated sentence of a different style when a sentence varies based on the gender of the author such as Japanese. An option audienceGender may indicate a gender of an intended audience and thereby be usefully used for a language that uses a different style based on the gender of the audience such as Spanish. An option outputType provides a function that enables the user to make a selection by providing the translation result to be singular or plural. An option TaggedInput is an option for specifying each part of a document or content spoken to have a different feature, and is an option of enabling a translation result suitable for a feature to be obtained by partially tagging a text to be translated. An option audienceAgeSpan is an option that enables a sentence to be translated in a talk-down style of Korean if the audience is a child. In table 1, ten translation options are described. However, it is only an example and thus, the range of the present invention is not limited to the above options.

Referring again to FIG. 1, according to an exemplary embodiment, when the translation server 100 provides a translation service based on an MPEG-M platform, a translation request message may be configured as the following extensible mark-up language (XML)-based code.

<?xml version=“1.0” encoding=“UTF-8”?>
<schema xmlns=“http://www.w3.org/2001/XMLSchema”
xmlns:mpegmb=“urn:mpeg:mpegM:schema:01-base-NS:2011”
xmlns:mpeg7=“urn:mpeg:mpeg7:schema:2004”
xmlns:tl=“urn:mpeg:mpegM:service-type:05-translate-
language-NS:2011”
targetNamespace=“urn:mpeg:mpegM:service-type:05-translate-
language-NS:2011”
elementFormDefault=“qualified”
attributeFormDefault=“unqualified”
version=“ISO/IEC 23006-4 2nd edition” id=“translate-
language.xsd”>
<import namespace=“urn:mpeg:mpegM:schema:01-base-NS:2011”
schemaLocation=“../mpeg-m-base.xsd”/>
<import namespace=“urn:mpeg:mpeg7:schema:2004”
schemaLocation=“../mpeg/mpeg7-v3.xsd”/>
<!-- Definition of Translate Language Service Type -->
<complexType name=“TranslateLanguageType”>

<complexContent>

<extension base=“mpegmb:RequestParametersBaseType”>

<sequence>

<element name=“SourceLanguage” type=“language”/>
<element name=“TargetLanguage” type=“language”/>

</sequence>

<attribute name=“DomainInfo” use=“optional”
default=“givenDomain”/>
<attribute name=“taggedInput” use=“optional”
type=“mpeg7:TermUseType”/>

<attribute name=“outputType” use=“optional”

default=“singleOutput”>

<simpleType>

<restriction base=“NMTOKEN”>

<enumeration value=“singleOutput”/>
<enumeration value=“multipleOutput”/>

</restriction>

</simpleType>

</attribute>
<attribute name=“linguisticStyle” use=“optional”

default=“formal”>

<simpleType>

<union>

<simpleType>

<restriction base=“NMTOKEN”>

<enumeration value=“formal”/>
<enumeration value=“informal”/>

</restriction>

</simpleType>
<simpleType>

<restriction base=“mpeg7:termReferenceType”/>

</simpleType>

</union>

</simpleType>

</attribute>
<attribute name=“writerGender” use=“optional”

default=“unspecified”>

<simpleType>

<restriction base=“NMTOKEN”>

<enumeration value=“female”/>
<enumeration value=“male”/>
<enumeration value=“neuter”/>
<enumeration value=“unspecified”/>

</restriction>

</simpleType>

</attribute>
<attribute name=“audienceGender” use=“optional”

default=“unspecified”>

<simpleType>

<restriction base=“NMTOKEN”>

<enumeration value=“female”/>
<enumeration value=“male”/>
<enumeration value=“neuter”/>
<enumeration value=“unspecified”/>

</restriction>

</simpleType>

</attribute>
<attribute name=“audienceAgeSpan” use=“optional”

default=“adult”>

<simpleType>

<restriction base=“NMTOKEN”>

<enumeration value=“child”/>
<enumeration value=“adult”/>

</restriction>

</simpleType>

</attribute>

</extension>

</complexContent>

</complexType>

</schema>

According to an exemplary embodiment, when the translation server 100 provides the translation service based on the MPEG-M platform, “TranslateLanguageType” may be configured as follows.

<?xml version=“1.0” encoding=“UTF-8”?>
<mpegmb:ServiceType

xmlns:xsi=“http://www.w3.org/2001/XMLSchema-instance”
xmlns:mpegmb=“urn:mpeg:mpegM:schema:01-base-NS:2011”
xmlns:ss=“urn:mpeg:mpegM:service-type:02-translate-
language-NS:2011”>

<mpegmb:ServiceTypeIdentifier>urn:mpeg:mpegM:service-

type:02- translate-language-
NS:2011</mpegmb:ServiceTypeIdentifier>

<mpegmb:Name> Translate Language </mpegmb:Name>
<mpegmb:RequestParametersType>ss: TranslateLanguage

Type</mpegmb:RequestParametersType>

</mpegmb:ServiceType>

According to an exemplary embodiment, when the MPEG-M platform is installed in the translation server 100, a ProcessContentResponse message may be transferred as an ACK signal and be configured as follows.

<mpegm:ProcessContentResponse>
<mpegmb:TransactionIdentifier>35</mpegmb:Transactionldentifier>

<mpegm:ProcessContentSuccess/>

</mpegm:ProcessContentResponse>

Hereinafter, the display unit 220 to display the translation option setting menu for the user will be further described with reference to FIGS. 3 through 6.

FIGS. 3 through 6 are exemplary diagrams illustrating a translation option setting menu 222 displayed on the display unit 220 of the user terminal 200 according to an exemplary embodiment of the present invention.

Referring to FIG. 3, the translation option setting menu 222 according to the present exemplary embodiment may include a first menu 222a including a radio button typed interface element for optional selection in order to indicate whether an expression style of a target language of a translated sentence is formal or informal, a second menu 222b and a third menu 222c including a selective element for designating a source language or the target language, and a fourth menu 222d including an element capable of setting a gender of an author of the source sentence, which is similar to the first menu 222a.

The first menu through the fourth menu 222a, 222b, 222c, and 222d enhance user convenience by visually providing a user with a definable option in defining a translation option based on a data type format of a message generated using the aforementioned translation options. Accordingly, a subsequent operation is performed by receiving an interface command such as a touch and the like from the user or from an input/output (I/O) device including a mouse, a keyboard, and the like through a menu screen displayed on the display unit 220 of the user terminal 200, and transmitting, to the control unit 210, a signal that maps the received interface command. Performing the operation includes generating a process content message according to the signal that maps the interface command. In the present exemplary embodiment, the process content message is a set of source codes constituted using a computer-readable language and includes a translation option defined by the user.

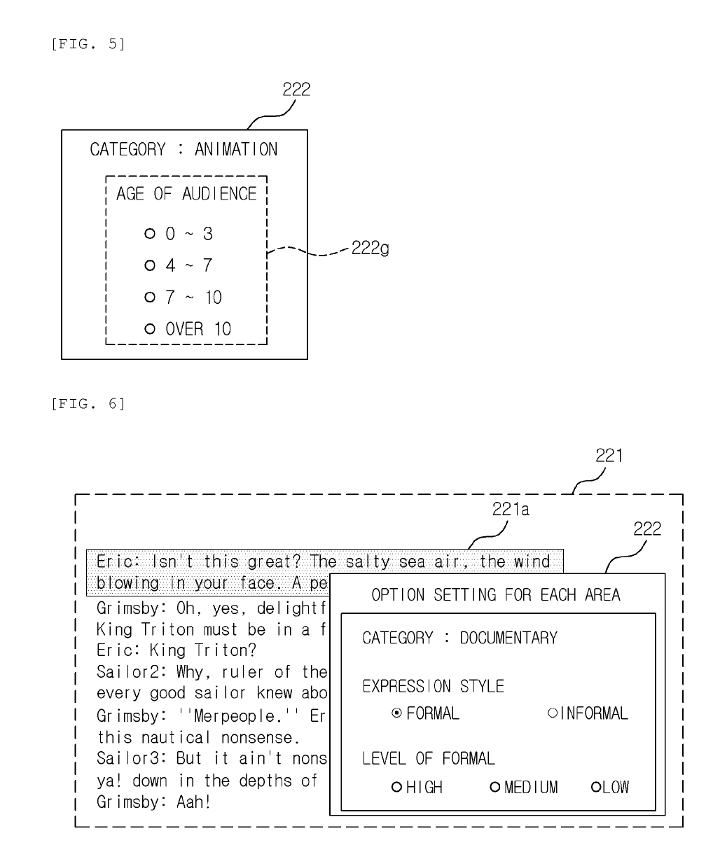

Referring to FIG. 4, in the present exemplary embodiment, a category of the source sentence may be designated using the translation option setting menu 222. Here, the translation option setting menu 222 may provide a default option value of a translation option for each category and may display, on one side of the display unit 220, a menu that may be changed by the user.

When a source sentence desired to be translated in the present exemplary embodiment is content of an IPTV according to MPEG-M (MSPT) that is a standard about a method of processing multimedia and an expression and a structure, the category of the source sentence may be classification information according to a description of content such as a movie, a sport, education, a documentary, an animation, and the like. Alternatively, when the source sentence is a text, the category of the source sentence may be classification information according to a variety of criteria such as general dialogue, news, a speech, a novel, and the like.

FIG. 4 is an example illustrating a case in which a category of a source sentence is a ‘documentary’. ‘Formal’ is set as a default option value of a translation option for each category (222e). Instead, a menu 222f dividing a detailed option with respect to a level of ‘formal’ in ‘high’, ‘medium’, and ‘low’ and thereby including an element for setting a level of ‘formal’ to be selectable by the user is provided. In general, purpose of the documentary is to transfer reality information to the user. Therefore, in many cases, the documentary is generally provided in a formal language such as an honorific language compared to a drama or a movie. In the present exemplary embodiment, by setting and thereby providing a translation option about ‘formal’ as a default value among translation options, or further by enabling the user to set a specific level of ‘formal’, it is possible to increase a user satisfaction or accuracy of the translated sentence.

As another example, referring to FIG. 5, the translation option setting menu 222 displays a menu 222g including an element capable of selecting an age of audience. An animation has a variety of types. Taking an educational animation for children as an example, a translation level of a source sentence provided by the animation may be selected based on an understanding level of children who view the animation. Accordingly, in the present exemplary embodiment, the translation level of the source sentence may be defined as the translation option using age information of audience received by providing the element capable of selecting the age of audience of the animation.

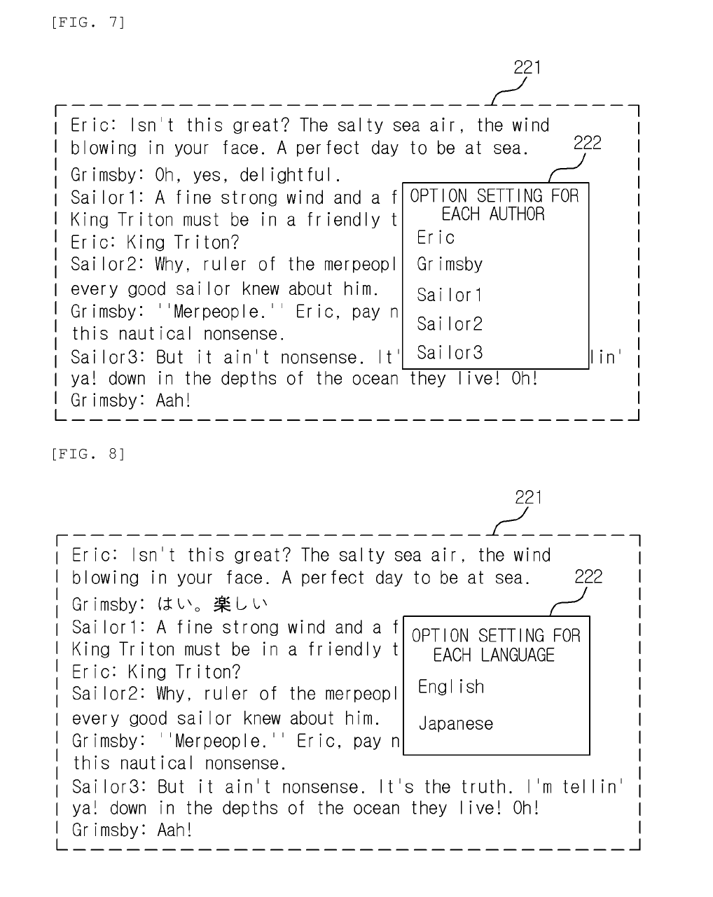

According to an exemplary embodiment, the translation option setting menu 222 capable of receiving a translation option on the entire data or partial data of the source sentence may be displayed on the display unit 220. It will be described with reference to FIGS. 6 through 8. In the present exemplary embodiment, partial data indicates a portion of the source data. Therefore, in this case, the translation option defined by the user may be designating an option with respect to the entire source option, or may be designating an option with respect to a portion of the source sentence.

Here, depending on exemplary embodiments, when designating a portion of the source sentence, it may be designating the translation option by physically dividing the source sentence, and in a case in which a plurality of persons participates in a dialogue, may be designating the translation option for each of the persons that participate in the dialogue.

Referring to FIG. 6, when the user designates a portion of a source sentence 221, for example, an area 221a corresponding to a dialogue portion of Eric “Isn't this great? The salty sea air, the wind blowing in your face. A perfect day to be at sea.”, and pushes a predetermined button, for example, a right click button of a mouse, or selects a predetermined menu, the translation option selection menu 222 may be displayed. In FIG. 6, as an example, the translation option setting menu 222 for setting a level of ‘formal’ when a category of source data is a documentary as described above with reference to FIG. 4 may be displayed. However, a screen for setting various options such as an option setting screen with respect to an author or an audience may be displayed. The user may set a translation option on the selected area 221a using the displayed translation option setting menu 222. The set option is applied only to the selected area 221a.

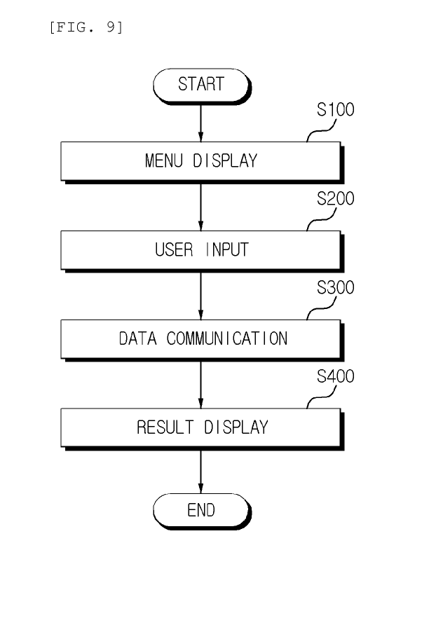

As illustrated in FIG. 7, when the source sentence 221 includes a dialogue between a plurality of persons who participates in the dialogue, a translation option may be set for each of the persons who participate in the dialogue. In FIG. 7, a plurality of authors, such as Eric, Grimsby, Sailor1, and the like are present in the source sentence 221. When the user pushes a predetermined button, for example, a right click button of a mouse or selects a predetermined menu, an option setting menu 222 for each author may be displayed. When the user select a single author from the option setting menu 222 for each author, a option setting menu corresponding to the selected author may be displayed and the user may set a translation option with respect to the author using the displayed option setting menu. The set translation option is applied only to the selected author. According to an exemplary embodiment of the present invention, when the source sentence 221 includes a plurality of languages, it is possible to set a translation option for each language. For example, as illustrated in FIG. 8, in a case in which English and Japanese are included in the source sentence 221, when the user pushes a predetermined button, for example, a right click button of a mouse or selects a predetermined menu, a language selection menu 222 may be displayed. The user may select a single language from the displayed menu 222 and thereby select a translation option with respect to the selected language. The set option is applied only to the language.

Hereinafter, a translation service providing method performed in the translation service providing apparatus 200 according to an exemplary embodiment of the present invention will be described with reference to FIGS. 9 through 11.

FIG. 9 is a flowchart illustrating a method of providing a translation service based on a user interface according to an exemplary embodiment of the present invention. Referring to FIG. 9, the translation service providing method according to the present exemplary embodiment includes a menu display operation S100, a user input operation S200, a data communication operation S300, and a result display operation S400.

As described above, the menu display operation S100 is an operation of displaying, by the display unit 220, a translation option setting menu for a user with respect to a source sentence of which a category is designated and to be translated.

The user input operation S200 is an operation of receiving, by the user input unit 240 from the user, an input on setting of a translation option. The data communication operation S300 is an operation of transmitting, by the communication unit 230, the translation option to a translation server (S320), and receiving a translation result from the translation server (S330).

The translation option received in the user input operation S200 may be a translation option with respect to the entire data or at least one partial data of the source sentence. The translation option received in the user input operation S200 may be any one of a translation option that is determined based on the category of the source sentence, a translation option for each author with respect to at least one author selected from the source sentence, and a translation option for each language with respect to at least one language selected from the source sentence.

Finally, the result displaying operation S400 is an operation of displaying, by the display unit 220, the translation result according to the received translation option.

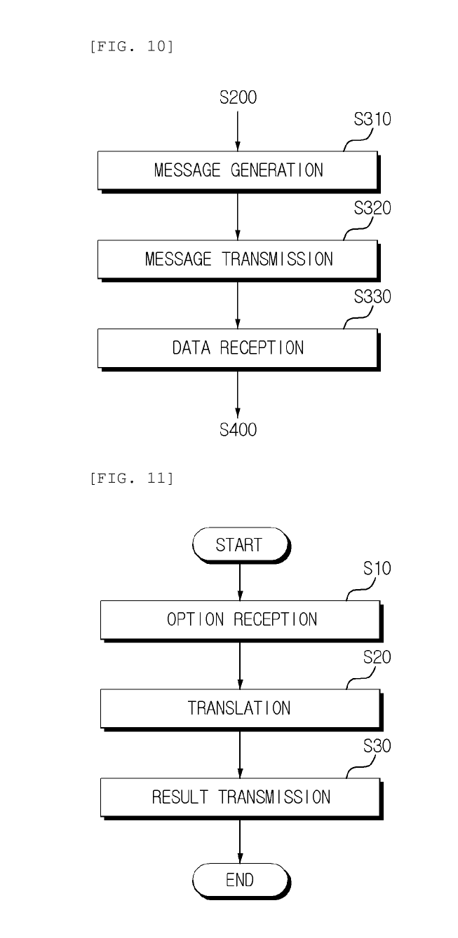

Further describing the data communication operation S300 in detail with reference to FIG. 10, the data communication operation S300 includes a message generation operation S310, a message transmission operation S320, and a data reception operation S330.

The message generation operation S310 generates a translation request message for requesting translation of the source sentence using the translation option, and the message transmission operation S320 transmits, to a data translation apparatus, the translation request message generated in the generating. The data reception operation S330 receives, from a source sentence translation apparatus, a sentence that is translated based on the translation option.

As described above, in the present exemplary embodiment, the data translation apparatus may be configured as a separate processor and may also be configured to be within the user terminal 200 based on performance of the user terminal 200. Here, the transmitter 234 and the receiver 236 of the communication unit 230 may communicate with a data translation module as an internal data translation apparatus.

Describing the translation service providing method of the present exemplary embodiment on a side of the data translation apparatus, that is, the translation server 100 with reference to FIG. 11, the translation service providing method includes an option reception operation S10 of receiving, from the user terminal 200, a source sentence of which a category is designated and to be translated and a translation option of the source sentence, a translation operation S20 of translating the source sentence by applying the translation option, and a result transmission operation S30 of transmitting the translation result to the user terminal 200.

The translation option received in the option reception operation S10 may be determined based on the category of the source sentence, or may be a translation option for each author with respect to at least one author selected from the source sentence or a translation option for each language with respect to each of at least one language selected from the source sentence.

Even though a case in which the data translation apparatus is configured as the separate translation server 100 is described in FIG. 11, the data translation apparatus in the present exemplary, as described above, may be configured to be within the user terminal 200 based on performance of the user terminal 200. Here, the transmitter 234 and the receiver 236 of the communication unit 230 may communicate with a data translation module as an internal data translation apparatus.

Various aspects, exemplary embodiments, implementations, or features of the present invention may be employed individually or using a predetermined combination. A variety of exemplary embodiments described herein may be implemented using, for example, software, hardware, or a combination thereof. According to hardware implementation, the exemplary embodiments described herein may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for performing a function. Here, software may be configured as a computer-readable code on the computer-readable media. The computer-readable media may be a predetermined data storage device capable of storing data later readable by a computer system. Examples of the computer-readable media include read only memory (ROM), random access memory (RAM), CD-ROM, digital versatile disks (DVD), magnetic tape, and optical data storage devices. The computer-readable media may also be distributed over network connection computer systems so that a computer-readable code may be stored and be executed using a distributed scheme.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A user terminal, comprising:
a display unit to display a translation option setting menu for a user with respect to a source sentence of which a category is designated and to be translated; a user input unit to receive, from the user, an input on setting of a translation option;
a communication unit to transmit the translation option to a translation server, and to receive a translation result from the translation server; and
a control unit to control operations of the display unit, the user input unit, and the communication unit.

2. The user terminal of claim 1, wherein the translation option received by the user input unit is a translation option with respect to the entire data or at least one partial data of the source sentence.

3. The user terminal of claim 1, wherein the translation option received by the user input unit is a translation option that is determined based on the category of the source sentence.

4. The user terminal of claim 1, wherein the translation option received by the user input unit is a translation option for each author with respect to at least one author selected from the source sentence.

5. The user terminal of claim 1, wherein the translation option received by the user input unit is a translation option for each language with respect to at least one language selected from the source sentence.

6. The user terminal of claim 1, wherein the communication unit comprises:
a message generator to generate a translation request message for requesting translation of the source sentence using the translation option;
a transmitter to transmit, to a data translation apparatus, the translation request message generated by the message generator; and
a receiver to receive, from a source sentence translation apparatus, a sentence that is translated based on the translation option.

7. The user terminal of claim 1, wherein:
the translation option includes source language information used to define a language of the source sentence, target language information used to define a target language for translating the source sentence, and information indicating whether an expression style of the target language is formal or informal, and
the translation option is a translation option that is selectable based on the source language or the target language.

8. The user terminal of claim 1, wherein the source sentence is data having a motion picture experts group (MPEG)-M based format.

9. A method of providing a translation service, the method comprising:
displaying a translation option setting menu for a user with respect to a source sentence of which a category is designated and to be translated;
receiving, from the user, an input on setting of a translation option;
transmitting the translation option to a translation server, and receiving a translation result from the translation server; and
displaying the translation result.

10. The method of claim 9, wherein the translation option received in the receiving is a translation option with respect to the entire data or at least one partial data of the source sentence.

11. The method of claim 9, wherein the translation option received in the receiving is a translation option that is determined based on the category of the source sentence.

12. The method of claim 9, wherein the translation option received in the receiving is a translation option for each author with respect to at least one author selected from the source sentence.

13. The method of claim 9, wherein the translation option received in the receiving is a translation option for each language with respect to at least one language selected from the source sentence.

14. The method of claim 9, wherein the transmitting and the receiving comprises:
generating a translation request message for requesting translation of the source sentence using the translation option;
transmitting, to a data translation apparatus, the translation request message generated in the generating; and
receiving, from a source sentence translation apparatus, a sentence that is translated based on the translation option.

15. The method of claim 9, wherein:
the translation option includes source language information used to define a language of the source sentence, target language information used to define a target language for translating the source sentence, and information indicating whether an expression style of the target language is formal or informal, and
the translation option is a translation option that is selectable based on the source language or the target language.

16. The method of claim 9, wherein the source sentence is data having an MPEG-M based format.

17. A translation service providing method of a translation server, the method comprising:
receiving, from a user terminal, a source sentence of which a category is designated and to be translated and a translation option of the source sentence;
translating the source sentence by applying the translation option; and
transmitting the translation result to the user terminal.

18. The method of claim 17, wherein the translation option received in the receiving is a translation option that is determined based on the category of the source sentence.

19. The method of claim 17, wherein the translation option received in the receiving is a translation option for each author with respect to at least author one selected from the source sentence.

20. The method of claim 17, wherein the translation option received in the receiving is a translation option for each language with respect to at least one language selected from the source sentence.
